(19) United States
(12) Patent Application Publication
(10) Pub. No.: US 2014/0195296 A1
(43) Pub. Date: Jul. 10, 2014

(54) METHOD AND SYSTEM FOR PREDICTING VIRAL ADVERTS TO AFFECT INVESTMENT STRATEGIES

(71) Applicant: FMR LLC, Boston, MA (US)

(72) Inventor: Conor Smyth, Crossmolina (IE)

(73) Assignee: FMR LLC, Boston, MA (US)

(21) Appl. No.: 13/734,031

(22) Filed: Jan. 4, 2013

(51) Int. Cl. G06Q 10/06

(52) U.S. Cl. CPC G06Q 10/0635
USPC 705/7.28

(57) ABSTRACT

A system for determining a viral entity in a networking environment is provided that includes a presentation tier module that includes a front end user interface to make application calls to start a service. A data tier module receives a selective application call from the presentation tier module and gathers known viral information to be benchmarked for further analysis. A logic tier module sends a request to the data tier module and employs stochastic modeling to process data from a plurality of sources that is likely to be viral.

### BACKGROUND OF THE INVENTION

The invention is related to the field of systems in operation with networking environments, and in particular to the unique identification and determination of data from social media that is likely to be deemed viral, and further, to assess an impact on a business.

Sifting through numerous websites to identify the latest news, gossip or current even can be time consuming. Further, the reliability of such an event being “current” or the “latest” is questionable, due in part to the vast number of a variety of available media sources. The prior art does not address applications of scanning or reading social networks, or websites, to determine if an story or entity will go viral, and then further, to determine what impact it will have on a business based on investment strategy.

### SUMMARY OF THE INVENTION

According to one aspect of the invention, there is provided a system for determining a viral entity in a networking environment. The system includes a presentation tier module that includes a front end user interface to make application calls to start a service. The system includes a data tier module that receives a selective application call from the presentation tier module and gathers known viral information to be benchmarked for further analysis. The system includes a logic tier module that sends a request to the data tier module and employs stochastic modeling to process data from a plurality of sources that is likely to be viral.

According to another aspect of the invention, there is provided a method of determining a viral entity in a networking environment. The method includes making application calls from a presentation tier module that includes a front end user interface to start a service. The method includes receiving a selective application call at a data tier module from the presentation tier module and gathering known viral information to be benchmarked for further analysis. The method includes employing stochastic modeling from a logic tier module that sends a request to the data tier module to process data from a plurality of sources that is likely to be viral.

### BRIEF DESCRIPTION OF THE DRAWINGS

FIG. 1 is a schematic diagram illustrating an embodiment of the system components operating in a networking environment; and

FIG. 2 is a schematic diagram illustrating the gathering and processing components of the Logic Tier Module.

### DETAILED DESCRIPTION OF THE INVENTION

An objective of the claimed invention is to predict events or stories, or “entities” that are viral on a network based on prior viral stories and their impact. In an exemplary embodiment, an “entity” in this case refers to, an article on BBC or Twitter status or RSS feed notice or a Facebook post or a YouTube post, or any other social media site, news site, or blog sites. A “viral” story is a story that becomes popular through the process of Internet sharing, including but not limited to, such as video sharing websites, social media and email. The prediction level of the story going viral will dictate the likelihood of becoming viral, as well as how likely it is impact a company. The invention provides a unique way to predict when these entities will become viral. A “source” is a news agency website or a social media site or a micro blogging site. An artifact is a method of storage of the raw java code. It can be divided in to either an OSGi Bundle or a JAR.

The code gathers the stories, videos, links, posts or statuses such that a prediction level will indicate how likely the entity is to becoming viral. The code consists of learning algorithms and detection of new sources. For example, for the top hundred webs sites, it should include api/interface calls to the application. Once a entity has been identified as potentially becoming viral, then a user or company can make decisions based on this knowledge. The application will provide a dashboard comprising relevant statistics, such as what key words are associated, and its probability that an entity will become viral. The invention includes code that will contact sources through an application program interfaces or through RSS feeds/atom feeds so that it can determine if the entity is going to become viral and if this is a similar entity to the original, while also determining a business impact. Accordingly, this should provide the information that is required to predict if the entity will become viral. A general user interface is used to configure the threshold, specific sources, and what sources should be dynamically added to the application. The user or the company can enter extra or specific sources or keywords that might hold special business needs. The sources, for example, news/social media/blogs for calls will not be hard coded into the program; rather, these calls will be dynamic unless added by the user.

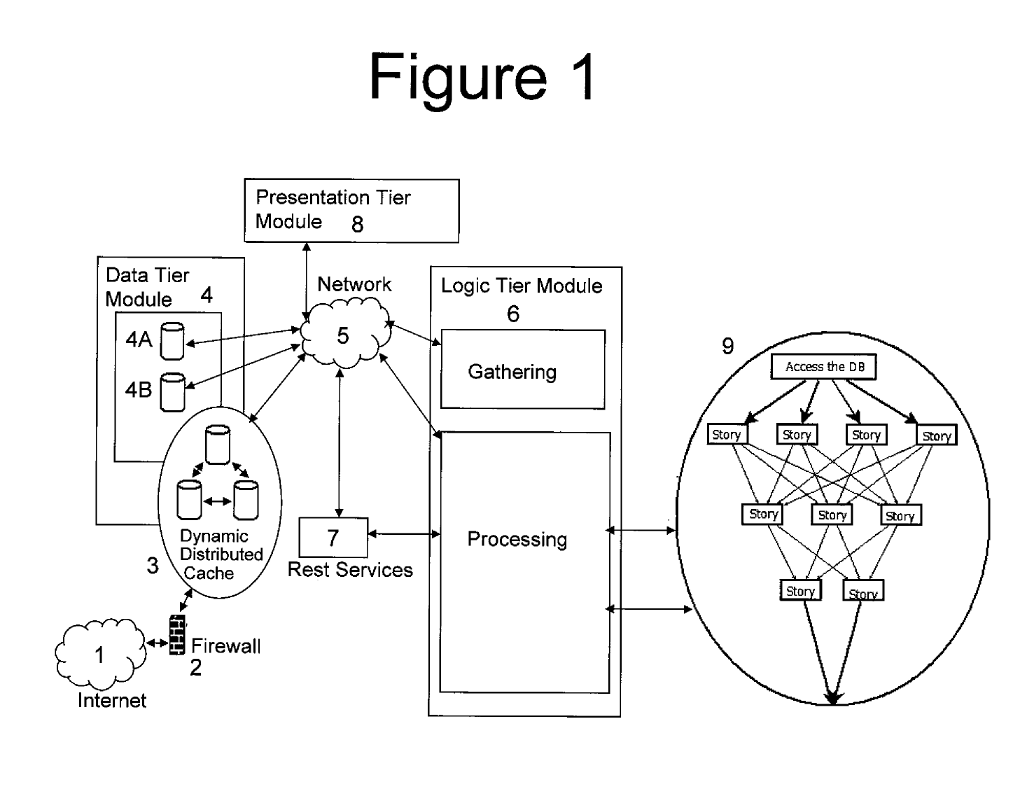

FIG. 1 shows an illustrative embodiment of the invention. The Internet 1 is used to gather information in front of a firewall 2. Such calls are tied to the gathering features of the Logic Tier Module 6, which will be described later in further detail. The firewall 2 is used to scan for potentially damaging information, including but not limited to, code, viruses or other malicious information. Sitting behind the firewall 2 is a distributed cache, where the information that is gathered is stored in a dynamic distributed cache 3. This cache 3 acts like a relational database management system (RDBMS) server spread over a plurality of machines, and as such, is a pseudo database that indexes the sources and the information that is retrieved. The cache 3 is connected through multi-casting or a network configuration that allows for distributed caching. The cache 3 uses artifacts from Logic Tier Module 6

The Data Tier Module—As a Middle Tier

The Data Tier Module 4 comprises of two separate databases, a known viral information database 4A, and a key word repository database 4B. The database 4A houses known viral information that has already occurred, such that the application will be able to benchmark against. This information in the database 4A can either be added by another application or can be used to house information that the claimed invention has gathered after using a multi-layer perceptron algorithm 10, which will be described later in further detail. The database 4B is a keyword repository server, where a plurality of keywords is ranked according to needs of a business or risk to the business. The database 4B comprises keywords that are related to the core of the business.

The Data Tier Module 4 is also responsible for the queries and the organization of data for the Logic Tier Module 6. It will use such techniques such as noSQL and/or pl/sql to map the information back from the Logic Tier Module 6 The back end, or the Logic Tier Module 6, will have determined if an entity is likely to become viral, so the middle tier, or the Data Tier Module 4, must determine if that entity is relevant to the business. The Data Tier Module 4 assigns a weight-based system using the keywords, the number of words in an entity, and how many other sources in which this entity is found. A weight based system in this context means that the number of key words found in the entity are divided by the overall number of words in the entity. EG: If there are 3 key words found in an entity that has 200 words. The application will use the rank of the key words. If the ranks of the key words are low then that entity will be given a low rank. However if the article has appeared in a numerous sources then the entity rank will increase.

Furthermore, the Data Tier Module 4 allows connections to be compared to other databases, such as oracle servers or Apache Hadoop servers. An extensive list of keywords, names, and businesses and stock names could be checked. This Data Tier Module 4 will check the relevant entity against other sources, and can be linked using Apache Hadoop and noSQL. A server should expose rest calls to this application. The Logic Tier Module 6 artifacts should expose a set of REST Services/Resources for the presentation tier to engage with the data tier module 4 and use the key words from the database 4B.

The Data Tier Module 4 accepts calls from the Logic Tier Module 6 to try match key words from 4B that are contained in potentially viral entities. The application uses words of estimative probability to search the entity too so that it will be able to predict future behavior. The application removes, for example, the 100 most common words from the entity before it carries out the search to the Apache Hadoop servers, or exposed rest services 7. If one of those common words is a key word in 4B then the article will be given a higher ranking. The application counts up the words in the entity excluding the above-mentioned 100 most common words, and sends each word to the noSQL service where it will compare it to the RMDBS. The artifacts in the Logic Tier Module 6 can use Zipfs law to determine the frequency of words in an entity, the Logic Tier Module 6 makes a call out to the Data Tier Module 4 for the Key Words Database 4B. Depending on the number of relevant words appearing in an entity, the application calculates a percentage on the number of overall words. This percentage will determine if this entity is worthy of searching the other sources for similar entities, and will use the same requirements that it used to perform the searches in the Apache Hadoop servers.

The more entities that the application consumes, the quicker it will be able to identify entities that are more relevant to the business, thereby reducing the number of calls to be made to the Data Tier Modules. By using Bayesian probability, the application will be able to predict that this is the same entity that was searched for on the dynamnic-distributed servers.

An internal local network 5 contains all of these servers and applications. It connects all of the modules, namely the Data Tier Module 4, the Logic Tier Module 6 and the Presentation Tier Module 8, using an IP LAN network.

The Logic Tier Module—As a Back End

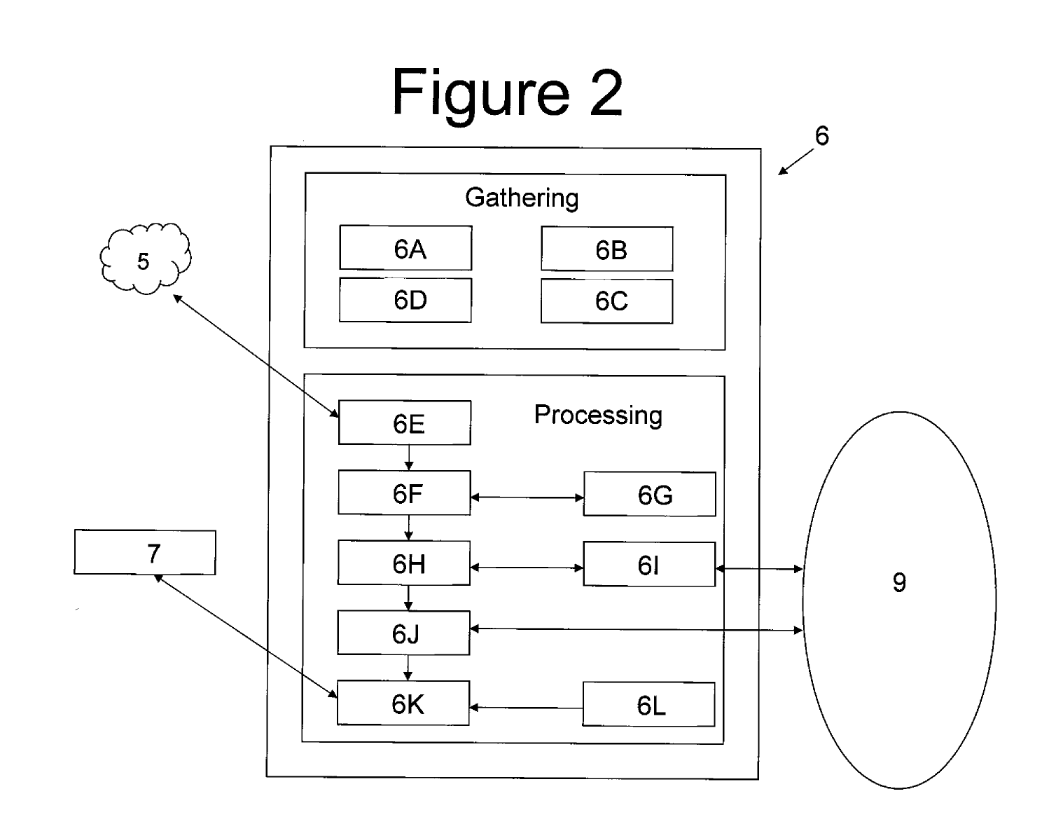

FIG. 2 illustrates an embodiment of components of the Logic Tier Module 6 in connection with the network 5, the rest services 7 and the information obtained from the entities by employing stochastic modeling 9. The back end of the application, or the Logic Tier Module 6, makes calls to social media, where such media can include YouTube, Google Plus, Facebook, BBC News, CNN News, and Twitter, all connected through APIs or pull all RSS feeds from these sites. Information to be gathered includes how many views a particular entity has received, and when the entity was created or last updated. The Logic Tier Module 6 will tag a page in a first round, and then check it, for example but not limited to, after a determined time period, such as 10 seconds later. If the number of views exceeds what it expected, then it will raise it as a possible entity for going viral. If it exceeds a predetermined time period (for example, in 1 hour, a entity has received 2 million views and the views are still increasing in a steeper rate.), then this is likely to be a viral entity, and as such, this entity should be flagged as viral.

The application masks the views and volume against an exponential graph. If the views and the volume of views exceed the predicted numbers, then the story will be flagged as a potential candidate for filtering based on keywords of the business. This volume is defined as the number of unique page hits that it has received, or on how many sources have the same link that is used or quoted. The application should give a clear indication that an entity is about to go viral. Using a first pass of volume and time as two points, the Logic Tier Module 6 makes a number of calls after a period of time. If the volume rate matches the time frame, then a consistency is exhibited, meaning that the entity is trending. If the volume rate exceeds the time frame, then it is likely to be viral. If the volume rate is lower than the time frame, then it is underperforming and, as such, is likely that it will not go any further. The Logic Tier Module 6 is placed on a Java Virtual Machine, for whichever server is best suited to this can be used. For example, such a server could be, and not limited to, Apache Felix , Linux, Microsoft Windows Eclipse Equinox or Apache Tomcat. The Logic Tier Module 6 comprises two sub-modules, namely, a gathering sub-module which comprises a plurality of separate features, each depicted by a first set a of a plurality of artifacts, and a processing sub-module which comprises a second set of a plurality of artifacts. Each set of artifacts are a collection of source code that has been compiled by a JVM but not limited to a JVM . A build lifecyle and management tool can be used to compile and deploy both of these sets of artifacts into the JVM, and the code is developed in Java. As a result, this allows for quicker compartmentalization of the structure. The compartmentalization refers to the fact that each artifact is designed with compiled code with common theme.

With respect to the gathering sub-module, a first artifact 6A comprises a feature to determine the top 100 websites from the Internet 1 that is based on traffic volume, and informs a WebCrawler to be more thorough when crawling through these sources. Another artifact 6B comprises a feature that handles the connection to the social media application programming interface (API) and handles the requests and responses to and from social media. Another artifact 6C comprises a feature that is compares the information gathered against other websites in order to determine the similarity of the information. Another artifact 6D comprises a feature to gather similar information that may be contained on other websites. By use of the multi-layer perceptron algorithm 10, it is determined if the entity is the same as the one that the claimed invention thinks is probably viral.

With respect to the processing sub-module, a first artifact 6E comprises a feature that makes calls to the keyword database and searches the information using full text searching (for example, Apache Lucene). Once a rank of the entity has surpassed a level that indicates that it is of business value of business need, then the information is passed on to the next artifact 6F. The next artifact 6F comprises a feature that compares the current information against known viral entities, and use connections to the databases that have known viral statistics. The artifact 6F uses the artifact 6G to make the connection and map the information from the entity to the database. The artifact 6G contains the actual connection and mapper details for the information and the mapping and masking it to the database information, and uses object relational mapping (ORM) to connect to the database, ideally Java Persistance API (JPA) or Hibernate. The artifact 6H comprises a feature that discovers if the information obtained is probably viral, and subsequently determines how quick to check either the main source or the dynamic distributed cache 3, whichever is the latest one.

The artifact 6I includes a feature to determine if the information is actually viral, based upon stochastic modeling 9. Stochastic modeling is the measuring of probability. It is used widely in the financial industry and the insurance industry. Simply it is put as the projection of certain type of event happening based on whatever you are projecting. In this case we are looking for the most likely case that an entity is viral of the information. The artifact 6J includes a feature to determine if the story is highly infectious information or actually viral information, using the multi-layer perceptron algorithm 10 and known statistics to determine how viral the information is. The artifact 6K comprises a feature to ensure how the information will be written to the known viral database and how it will be displayed to an end user. This artifact 6K will use connections used in artifact 6G to map the information. The artifact 6L comprises a feature of sentiment to determine if the information is either positive or negative to a need of the business. This sentiment feature affects the priority of the information to the user depending on how positive or negative the information is.

If it is determined that the information is extremely negative. Extreme is defined in this context as the percentage of negative words out of the overall possible out of all the possible words. For example, if 92 is the number of negative words tout of a possible 100 words in the entity then this is likely to be extremely negative. The closer the amount of negative words reaches the total number of words in the entity the more likely it is to be extreme. Ranges will determine severity of the sentiment, then the information is pushed to the user immediately and the application monitors the user's response. If it is determined that the information is positive, it pushes the information but it will allow the user decide on what to progress with.

Referring back to FIG. 1, an open source services framework, Apache CXF, acts as an exposed rest service 7 for the user interface at the Presentation Tier Module 8. If the user is looking for information that might be relevant, the rest service 7 is exposed to the Presentation Tier Module 8 where the user can make calls through a user interface.

The Presentation Tier Module—As a Front End

The Presentation Tier Module 8 is used to host a front end user interface to the user that uses json calls to a back end rest service, where it will obtain the information from. The Presentation Tier Module 8 also comprises an API which is exposed through the back end rest service such that a business unit could potentially interact with the Logic Tier Module 6 for their own purpose, without affecting the main code or the main application. The Presentation Tier Module 8 consists of a GUI and a plurality of dashboards that allows users of a business to view statistics of new entities, entities that are becoming viral, and what is trending. The main dashboard selects sources that they may wish to monitor specifically for viral information. However the this patent will gather from all sources and determine if any entity is likely to go viral and then notify the user in case it might be relevant to them using the Data Tier Module 4 and cache 3 to gather other keywords that might be relevant to the business. The GUI allow the user to categorize the entities in to the following categories: Rejected; Relevant; Impact.,

These categories are a simply a way of the gui information gathering information on what entities the user is actually looking for. These categories can be passed to stochastic modeling 6I. So that if a large amount of users deem certain information irrelevant then Logic Tier Module 6 can reduce the entities ranking there by reducing the significance to future entities . If the entity is not relevant to the business or not becoming viral, it will be rejected either because of a small number of keywords or small volumes. The small number of key words will be determined by the number of key words that are found in the entity compared against the number of overall entity. EG: If an entity has 100 words and the key word is high-ranking business key word. The application should check for the number of views if the number of views increases over a shorter and shorter space of time this indicates that it is likely that it will become viral. However if the same entity has I key word that is low/insignificant to the business then it is unlikely that no matter what the number of views are the entity is irrelevant. The word volumes is defined as but not limited to the number of views an entity has or is likely to have.

If the entity is not becoming viral but may be of some relevant to the business, it will be marked on the front end as trending along with consistent volumes. Consistent volumes are volumes that have steadily increased since this application started monitoring it. It is defined as increasing in a linear fashion. The application can constantly monitor entities that show a linear volume and contain a considerably proportion of keywords compared to the overall entity.

If an entity is not relevant at all, the application should not store these results. The application will only store results that are not relevant in the Dynamic Distributed cache if they have insignificant volume (as defined above) or have no key words. The cache will remove this irrelevant entity after a time frame that will be defined by the configuration of this dynamic distributed cache. The application should also consult the results of this application to check if there exist the same keywords in the same sequence and the same volumes with a percentage of error.

Although the present invention has been shown and described with respect to several preferred embodiments thereof, various changes, omissions and additions to the form and detail thereof, may be made therein, without departing from the spirit and scope of the invention.

What is claimed is:

1. A system for determining a viral entity in a networking environment, comprising:
a presentation tier module executing on a first processor that includes a front end user interface to make application calls to start a service;
a data tier module that receives a selective application call from said presentation tier module and gathers known viral information to be benchmarked for further analysis; and
a logic tier module executing on a second processor that sends a request to said data tier module and employs stochastic modeling to process data from a plurality of sources, the logic tier determines the frequency of selected words appearing in the data and calculates a percentage of the various sources associated with the selected words to determine whether to search other respective networks for similar information, wherein a map of the data is provided that connects the various sources associated with the data to a user so as to determine the popularity or viralness of the data.

2. The system of claim 1, wherein said data tier module comprises a first database and a second database, said first database comprises known viral information and said second database comprises a repository of keywords.

3. The system of claim 2, wherein said key words are ranked according to business needs or risk to a business.

4. The system of claim 1 further comprising a dynamic distributed cache having a plurality of servers, said cache indexes said plurality of sources.

5. The system of claim 1, wherein said logic tier module comprises a gathering sub-module and a processing sub-module, said gathering sub-module comprises a first set of a plurality of artifacts and said processing sub-module comprises a second set of a plurality of bundles.

6. The system of claim 5, wherein said first set of artifacts.

7. The system of claim 5, wherein a artifact of said second set of artifacts of said processing sub-module comprises a feature to ensure how data is written to said first database and how data will be displayed to said presentation tier module.

8. The system of claim 5, wherein a artifact of said second set of artifacts of said processing sub-module comprises a sentiment feature to determine if the data is either positive or negative to a need of a business.

9. The system of claim 1, wherein said sources include social media websites, Internet sharing and email.

10. A method for determining a viral entity in a networking environment, comprising the steps of
making application calls from a presentation tier module executing on a first processor that includes a front end user interface to start a service;
receiving a selective application call at a data tier module from said presentation tier module and gathering known viral information to be benchmarked for further analysis; and
employing stochastic modeling from a logic tier module executing on a second processor that sends a request to said data tier module to process data from a plurality of sources, the logic tier determines the frequency of selected words appearing in the data and calculates a percentage of the various sources associated with the selected words to determine whether to search other respective networks for similar information, wherein a map of the data is provided that connects the various sources associated with the data to a user so as to determine the popularity or viralness of the data.

11. The method of claim 10, wherein said data tier module comprises a first database and a second database, said first database comprises known viral information and said second database comprises a repository of keywords.

12. The method of claim 11, wherein said keywords are ranked according to business needs or risk to a business.

13. The method of claim 10 further comprising the step of indexing said plurality of sources from a dynamic distributed cache having a plurality of servers.

14. The method of claim 10, wherein said logic tier module comprises a gathering sub-module and a processing sub-module, said gathering sub-module comprises a first set of a plurality of artifacts and said processing sub-module comprises a second set of a plurality of artifacts.

15. The method of claim 14, wherein said first set of artifacts.

16. The method of claim 14, wherein a bundle of said second set of artifacts of said processing sub-module comprises a feature to ensure how data is written to said first database and how data will be displayed to said presentation tier module.

17. The method of claim 14, wherein a artifact of said second set of artifacts of said processing sub-module comprises a sentiment feature to determine if the data is either positive or negative to a need of a business.

18. The method of claim 10, wherein said sources include social media websites, Internet sharing and email.
